(19) United States
(12) Patent Application Publication
(10) Pub. No.: US 2025/0291998 A1
(43) Pub. Date: Sep. 18, 2025

(54) IC OPTIMIZATION DESIGN DEVICE AND IC OPTIMIZATION DESIGN METHOD

(71) Applicant: Axion Co., Ltd., Seongnam-si (KR)

(72) Inventors: Kee Sup KIM, El Dorado Hills, CA (US); Younggwang JUNG, Incheon (KR); Eun Taek OH, Seoul (KR); Yeong Bin YOU, Seongnam-si (KR)

(21) Appl. No.: 19/081,584

(22) Filed: Mar. 17, 2025

Related U.S. Application Data
(60) Provisional application No. 63/566,308, filed on Mar. 17, 2024.

(51) Int. Cl. G06F 30/398; G06F 119/12

(52) U.S. Cl. CPC G06F 30/398; G06F 2119/12

(57) ABSTRACT

The present disclosure relates to an integrated circuit optimization design device including an integrated circuit design generator configured to generate an integrated circuit design, a simulator configured to simulate the integrated circuit design, and an optimization engine configured to derive an optimal design parameter for the integrated circuit design by inputting a simulation result obtained from the simulator into an optimization model provided in advance, wherein the optimal design parameter includes asynchronous design information regarding the integrated circuit design generator, and the integrated circuit design generator asynchronously generates at least a part of the integrated circuit design according to the optimal design parameter to change the integrated circuit design. Thus, an optimal integrated circuit structure robust to process variations and capable of maximizing performance may be automatically generated by applying a design technology co-optimization (DTCO)-based design optimization technique that simultaneously takes into account a semiconductor manufacturing process and design optimization.

### CROSS-REFERENCE TO RELATED APPLICATION(S)

This application claims priority under 35 USC 119 to U.S. Provisional Application No. 63/566,308, filed on Mar. 17, 2024, the contents of which is incorporated herein by reference in its entirety.

### FIELD OF THE DISCLOSURE

The present disclosure relates to an integrated circuit optimization design device and an integrated circuit optimization design method for optimizing a design of an integrated circuit.

### BACKGROUND OF THE RELATED ART

In a semiconductor industry, optimization of performance (P), power consumption (P), and area (A) (power-performance-area (PPA)) is a key area in which continuous research and development is performed. In particular, as process technology has scaled down, complexity of semiconductor chips has increased. Thus, there is a need for a new approach to overcome limitations in general design methods and manufacturing processes.

As one of the methods to solve this problem, design technology co-optimization (DTCO) is drawing attention. DTCO is a methodology that systematically connects a semiconductor design and a manufacturing process to secure optimal performance and productivity. This is a method of inducing an optimized design by reflecting process constraints in consideration of manufacturability from an early design stage.

In particular, as semiconductor devices continue to become more miniaturized, synchronous design methods in the related art cause various problems.

First, a clock signal is driven continuously in synchronous circuits, which cause unnecessary clock transitions throughout entire chips. This may increase power consumption, which is a critical issue in a low-power design.

In addition, in recent semiconductor processes, process variations (PV) may affect timing and performance of a circuit, and synchronous designs are sensitive to the process variations. Thus, this may cause a problem of vulnerability to process variations.

On the other hand, in a design method using a clock signal, when variability of a signal transmission path is great, stable operation may not be ensured. Thus, clock jitter and timing closure problems may be caused.

Since semiconductor design methods in the related art are generally based on a synchronous design, optimization becomes increasingly difficult due to power consumption issues, an impact of process variations, and timing lockout caused by clock signals.

Particularly, in recent process technologies, there is an increasing importance of DTCO, like introduction of design techniques such as dual patterning to secure higher integration. However, a design structure in the synchronous method still has various limitations.

For example, unnecessary clock transitions need to be minimized for low-power design. However, it is difficult to effectively control the unnecessary clock transitions using the synchronous design methods in the related art. Thus, a problem in power efficiency may be caused. In addition, since all circuit blocks need to operate within a same clock domain, a problem such that design options that can be optimized are limited is present.

On the other hand, an asynchronous design is advantageous in power saving and performance optimization, but since environments for design automation tool (computer-aided design (CAD) or exploratory data analysis (EDA)) are optimized for the synchronous design, it is difficult to effectively apply the asynchronous design.

Therefore, there is a need for a method of optimizing a design of integrated circuits based on an asynchronous design method that may complement the synchronous design in the related art.

### SUMMARY OF THE INVENTION

### Technical Problems

Accordingly, the present disclosure has been made in view of the above-mentioned problems occurring in the related art, and it is an object of the present disclosure to provide an integrated circuit optimization design device and an integrated circuit optimization design method capable of automatically generating an optimal integrated circuit structure robust to process variations and capable of maximizing performance by applying a design technology co-optimization (DTCO)-based design optimization technique that simultaneously takes into account a semiconductor manufacturing process and design optimization.

### Technical Solution

To accomplish the above-mentioned objects, according to one aspect of the present disclosure, there is provided a an integrated circuit design generator configured to generate an integrated circuit design; a simulator configured to simulate the generated integrated circuit design; and an optimization engine configured to derive an optimal design parameter for the generated integrated circuit design by inputting a simulation result obtained from the simulator into an optimization model provided in advance, wherein the optimal design parameter includes asynchronous design information regarding the integrated circuit design generator, and the integrated circuit design generator asynchronously generates at least a part of the integrated circuit design according to the derived optimal design parameter to change the generated integrated circuit design.

In addition, wherein the optimization engine may include a target area exploration unit configured to explore information about a target area to which asynchronism is to be applied, among areas of the integrated circuit design.

In addition, the target area exploration unit may explore, as the target area, a design area vulnerable to a layout effect process variation or a timing variation using a process variation (PV) analysis model or a timing analysis model each provided in advance.

In addition, the target area may be an area including at least one of a block within the integrated circuit design and a sub-area in the block.

In addition, the simulator may include an estimator configured to predict asynchronous applicability by verifying whether a target value corresponding to a predefined optimization objective is reached.

In addition, the simulator may further include a timing analysis unit configured to determine whether a predefined timing event occurs by analyzing timing for at least one of a synchronous domain and an asynchronous domain based on a clock.

In addition, the timing analysis unit may include a clock domain crossing (CDC) analysis model configured to identify a CDC timing event which is a case in which a problem occurs when a signal is transmitted between domains with different clock cycles, and the CDC analysis model may be a model configured to automatically classify at least one CDC type when predefined CDC analysis target data is input.

In addition, the optimization engine may further include an asynchronous method determination unit configured to determine an asynchronous design method to be applied to the target area, based on at least one of predefined asynchronous design objectives.

In addition, the optimization engine may further include a design analysis unit configured to recommend a design option for an asynchronous design based on an integrated circuit design applied to the target area, when the target area is derived by the target area exploration unit.

In addition, the integrated circuit design generator may change the integrated circuit design by placing blocks in domains with a same clock to be adjacent to each other, or independently placing blocks in synchronous domains and performing an interface routing to prevent a signal collision between asynchronous domains, based on the optimal design parameter.

In addition, the integrated circuit design generator may convert the target area from a synchronous domain to an asynchronous domain.

Meanwhile, to accomplish the above-mentioned objects, there is provided an integrated circuit optimization design method including: generating, by an integrated circuit design generator, an integrated circuit design; simulating, by a simulator, the generated integrated circuit design; deriving, by an optimization engine, an optimal design parameter for the generated integrated circuit design by inputting a simulation result obtained from the simulator into an optimization model provided in advance, wherein the optimal design parameter includes asynchronous design information regarding the integrated circuit design generator, and the integrated circuit design generator asynchronously generates at least a part of the integrated circuit design according to the derived optimal design parameter to change the generated integrated circuit design.

In addition, the deriving of the optimal design parameter may include exploring, by a target area exploration unit, information about a target area to which asynchronism is applied, among areas of the integrated circuit design.

In addition, the exploring of the target area information may include exploring, as the target area, a design area vulnerable to a layout effect process variation or a timing variation using a process variation (PV) analysis model or a timing analysis model each provided in advance.

In addition, the target area may be an area including at least one of a block within the integrated circuit design and a sub-area in the block.

### Advantageous Effects

According to one aspect of the present disclosure described above, an integrated circuit optimization design device and an integrated circuit optimization design method may be provided to automatically generate an optimal integrated circuit structure robust to process variations and capable of maximizing performance by applying a design technology co-optimization (DTCO)-based design optimization technique in which a semiconductor manufacturing process and design optimization are simultaneously taken into account.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIGS. 1 and 2 are block diagrams for explaining components of an integrated circuit optimization design device according to an embodiment of the present disclosure;

FIGS. 3 to 6 are diagrams illustrating an example for explaining a process of converting a synchronous design to an asynchronous design by the integrated circuit optimization design device according to an embodiment of the present disclosure; and

FIG. 7 is a flowchart for explaining an integrated circuit optimization design method according to an embodiment of the present disclosure.

### DETAILED DESCRIPTION OF THE PREFERRED EMBODIMENT

Features and advantages of the technical solution of the present disclosure and methods of accomplishing the same may be understood more readily with reference to the following detailed description of particular embodiments of the present disclosure and the accompanying drawings.

However, certain detailed explanations of well-known functions relevant to the present disclosure are omitted when it is deemed that they may unnecessarily obscure the essence of the present disclosure. It should be noted that like reference numerals in the drawings denote like elements.

Hereinafter, terms or words used in the description and drawings should not be interpreted as being limited to have a general meaning or a meaning defined in a dictionary, but should be interpreted as having a meaning and a concept which are consistent with the technical ideas of the present disclosure, based on a principle such that an inventor may properly define concepts of the terms to explain the disclosure of the inventor by using an optimal method. Accordingly, it should be understood that embodiments in the specifications and configurations illustrated in drawings are only example embodiments, and there is no intent to limit the example embodiments to the particular forms disclosed, but on the contrary, example embodiments are to cover all modifications, equivalents, and alternatives falling within the scope of the present disclosure.

Additionally, when an element is referred to as being “connected” or “coupled” to another element, this means that the element may be logically or physically connected or coupled to the another element. In other words, it should be understood that the element may be directly connected or coupled to the another element, but intervening elements may be present or the element may be indirectly connected or coupled to the another element.

In addition, the terms used in the present specification are merely used to describe particular embodiments, and are not intended to limit the present disclosure. A singular representation may include a plural representation unless it represents a definitely different meaning from the context.

In addition, it is to be understood that the terms such as “including” or “having,” etc. described herein are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

The term “module” used in various embodiments herein may include a unit implemented in hardware, software or firmware, and may be used interchangeably with terms such as logic, logic block, component, or circuit.

In this specification, each component according to various embodiments (e.g., a module or a program) may contain one or more entities, and some of the entities may be separated and placed in other components. According to various embodiments, one or more of the aforementioned components or operations may be omitted, or one or more other components or operations may be added. Alternatively or additionally, a plurality of components (e.g. (modules or programs) may be integrated into a single component. In this case, the component resulting from the integration may perform one or more functions of each of the plurality of components identically or similarly to those performed by a corresponding component among the plurality of components before the integration.

According to various embodiments, operations performed by a module, program or other component may be performed sequentially, in parallel, iteratively, or heuristically, or one or more of the operations may be performed in a different order, omitted, or one or more other operations may be added.

Hereinafter, embodiments of the present disclosure will be described in detail with reference to the accompanying drawings.

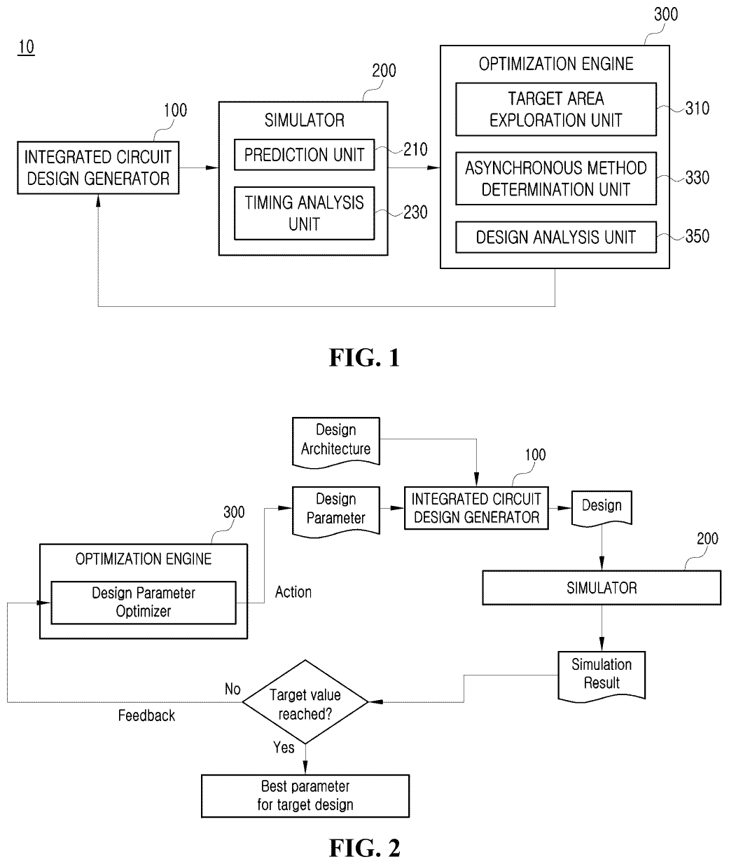

FIGS. 1 and 2 are block diagrams for explaining components of an integrated circuit optimization design device 10 according to an embodiment of the present disclosure;

The integrated circuit optimization design device 10 (hereinafter referred to as a device) according to the present embodiment is provided to automatically generate an optimized integrated circuit design by reflecting characteristics of an integrated circuit and user needs.

To do so, the device 10 according to the present embodiment may be configured to include an integrated circuit design generator 100, a simulator 200, and an optimization engine 300.

In addition, software (an application) configured to perform an integrated circuit optimization design method may be installed and executed in the device 10, and the integrated circuit design generator 100, the simulator 200, and the optimization engine 300 may be controlled by the software (the application) configured to perform the integrated circuit optimization design method.

At this time, the device 10 may be a separate terminal or a partial module of a terminal. Additionally, components such as the integrated circuit optimization design generator 100, the simulator 200 and the optimization engine 300 may be configured as an integrated module or one or more modules. However, conversely, respective components may be configured as separate modules.

Additionally, the device 10 may have mobility or be fixed. The device 10 may have a form of a server or an engine, or be referred to as other terms such as a device, an apparatus, a terminal, a user equipment (UE), a mobile station (MS), a wireless device, a handheld device, etc. In addition, the device 10 may execute or produce various software based on an operating system (OS), that is, a system. Here, the operating system refers to a system program that allows software to use hardware of a device, and may include a mobile computer operating system such as an Android OS, iPhone operating system (iOS), a Windows mobile OS, a Bada OS, a Symbian OS, or a Blackberry OS, as well as a computer operating system such as Windows, Linux, Unix, Macintosh (MAC), advanced interactive executive (AIX), or Hewlett Packard Unix (HP-UX).

Hereinafter, a detailed configuration of the device 10 is described. In synchronous designs for integrated circuit design in the related art, process variations (PVs) such as a local layout effect (LLE) or a neighborhood effect (NE) may occur. Thus, the synchronous designs in the related art utilizes a timing guard band (TGB) which is margin time additionally set to secure timing margin to ensure integrity of timing according to process variations. However, there is a problem in that the TGB takes up 15% of a clock cycle at maximum. In addition, the synchronous designs in the related art utilizes a design guard band (DGB) which is a margin additionally set to secure design safety to ensure integrity of performance and yield according to process variations. The DGB has such a problem that an operating speed of a circuit may be decreased or a maximum clock frequency may be reduced, and inefficiency may be also increased due to increases in power consumption and a chip area.

Accordingly, the device 10 according to the present embodiment may be provided to generate an integrated circuit design that meets a preset optimization objective by applying an asynchronous design for removing a TGB and a DGB to a part or whole of an integrated circuit.

First, the integrated circuit design generator 100 according to the present embodiment may perform a function of generating at least one designs according to a predefined criterium based on design data input to generate an integrated circuit design.

At this time, the design data may be input by a user or may be prestored. In addition, the design data may include an optimal design parameter derived from the optimization engine 300.

In addition, the integrated circuit design generator 100 according to the present embodiment may asynchronously generate at least a part of an integrated circuit design according to the optimal design parameter derived from the optimization engine 300 and change the generated integrated circuit design.

In addition, the integrated circuit design generator 100 may change the integrated circuit design generated based on the optimal design parameter until a predefined optimization objective is reached, or change the integrated circuit design by asynchronously generating at least a part of the integrated circuit design until a predefined asynchronous design objective is reached.

In detail, the integrated circuit design generator 100 according to the present embodiment is a mixed clock architecture used in a digital circuit design for synchronous-asynchronous interface optimization, which is one of asynchronous design objectives, based on an optimal design parameter derived from the optimization engine 300, and may perform global async local synchronization (GALS) optimization in which a whole system operates asynchronously but each local module operates synchronously.

To do so, the integrated circuit design generator 100 may execute independent placement for each clock domain. For example, the integrated circuit design generator 100 may change the integrated circuit design by placing blocks in domains with a same clock to be adjacent to each other based on clock tree clustering, independently placing blocks in synchronous domains to prevent clock collisions, or optimizing an interface routing to prevent signal collisions between asynchronous domains.

In addition, the integrated circuit design generator 100 may resolve a signal interference problem by optimizing an interface routing according to an optimal design parameter based on verification of signal integrity (SI) for optimization of the interface routing. To verity the signal integrity, signal integrity parameter prediction using artificial intelligence may also be performed.

Additionally, the integrated circuit design generator 100 may also convert a target area explored by the optimization engine 300 to be described later from a synchronous domain to an asynchronous domain.

FIGS. 3 to 6 are diagrams illustrating an example for explaining a process of converting a synchronous design to an asynchronous design by the integrated circuit optimization design generator 100.

The integrated circuit design generator 100 according to the present embodiment may perform a function of analyzing a clock domain for a target area within an integrated circuit as illustrated in FIG. 3.

By doing so, the integrated circuit design generator 100 may check whether the clock domain is a single clock domain using a single clock or a multi-clock domain using multiple clocks, and detect problems that may occur in a process of transmitting signals between different clock domains.

Additionally, the integrated circuit design generator 100 may analyze a trigger method based on a clock edge to clearly distinguish whether a signal operates at a positive edge or a negative edge. Through this analysis, the integrated circuit design generator 100 may support stable synchronization and reliable circuit design.

In addition, the integrated circuit design generator 100 may perform a function of analyzing a synchronous finite state machine (FSM).

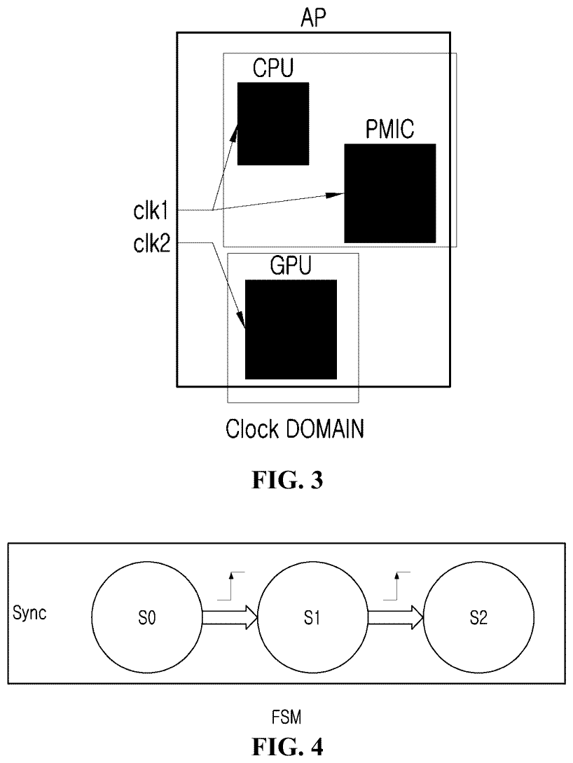

In detail, as shown in FIG. 4, the integrated circuit design generator 100 may analyze an FSM that performs a state transition based on a clock edge and identify a finite state that the system may have. In addition, as shown in FIG. 4, the integrated circuit design generator 100 may analyze a transition process to a next state according to a current state and a particular input condition to verify whether a designed FSM performs an expected operation. Additionally, the integrated circuit design generator 100 evaluates a relationship between an input and an output in each state to ensure an optimal operation while maintaining logical consistency.

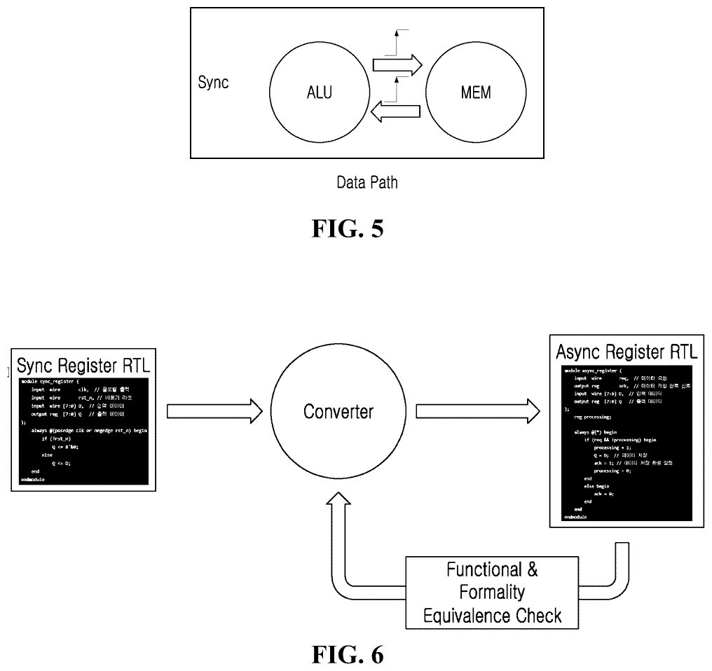

In addition, the integrated circuit design generator 100 according to the present embodiment may perform a function of analyzing a data path to identify a path along which data moves in a particular circuit as shown in FIG. 5. Thus, the integrated circuit design generator 100 may check presence of a plurality of clock domains within the data path and analyze how data is updated in each clock cycle. Additionally, the integrated circuit design generator 100 may check consistency and accuracy of a data flow by evaluating how the data is processed when a particular pattern is given.

Accordingly, as illustrated in FIG. 6, in a process of converting from a synchronous domain to an asynchronous domain in the target area, the integrated circuit design generator 100 according to the present embodiment may perform a function of verifying consistency and equivalence before and after the conversion based on the clock domain analysis, the FSM analysis, and the data path analysis described above. To do so, the integrated circuit design generator 100 may perform functional verification and formal verification. In detail, the integrated circuit design generator 100 may perform functional verification of checking operation of a converted design by applying various test patterns. Additionally, the integrated circuit design generator 100 may perform a formal verification operation of preventing a design error during the conversion process by reviewing whether a design before the conversion and a design after the conversion are logically equivalent to each other by analyzing all possible input combinations and states.

The integrated circuit design generator 100 according to the present embodiment may transmit a generated integrated circuit design or a changed integrated circuit design to the simulator 200 to simulate whether the generated integrated circuit design or the modified integrated circuit design meets a predefined optimization objective.

Meanwhile, the simulator 200 according to the present embodiment is provided to simulate an integrated circuit design generated by the integrated circuit design generator 100. In detail, the simulator 200 may perform a function of predicting in advance an impact of asynchronous conversion on an integrated circuit design structure and performance and determining whether or not to perform the asynchronous conversion. In general, it may not be desirable to asynchronously convert all of respective blocks in a design comprehensively.

Therefore, the simulator 200 according to the present embodiment may provide a function of predicting performance changes and overhead to determine whether to perform asynchronous conversion in units of a block. By doing so, design optimization may be maximized and unnecessary performance degradation may be prevented.

To do so, the simulator 200 according to the present embodiment may include a prediction unit 210 and a timing analysis unit 230.

The prediction unit 210 according to the present embodiment may predict an asynchronous application possibility by verifying whether a target value corresponding to a predefined optimization objective is reached. To do so, the prediction unit 210 may perform a function of predicting, in advance, performance changes and overhead expected after the asynchronous conversion of the target area to establish an optimal change strategy. The prediction unit 210 may use a machine learning-based prediction method and a trial placement & routing (P&R)-based prediction method.

When the prediction unit 210 is based on the machine learning-based prediction method, existing design data may be used to learn performance changes after the asynchronous conversion, and based on this, prediction may be performed. In detail, the prediction unit 210 may predict performance changes, area overhead, power overhead, etc. through a machine learning model trained by using structural characteristics of each block, an amount of TGB or DGB in an existing block, expected timing changes, etc. as inputs (features). As such, when a pre-trained model is utilized, fast predictions may be performed, and precise predictions may be performed by taking into account patterns that may occur in various designs.

In addition, when the prediction unit 210 is based on the trial P&R-based prediction method such that measurements are repeated until a result of the measurements converge and a number of the repetitions is limited, limited P&R may be performed on some blocks or a whole design to directly measure a performance change when actual asynchronous conversion has occurred. In detail, the prediction unit 210 may perform the P&R using minimum resources, and then, estimate an impact on the whole design based on a corresponding result.

Additionally, the prediction unit 210 may complement an asynchronous conversion strategy in combination with a reinforcement learning (RL)-based optimization process, and may also evaluate a possibility of design optimization by converting a particular block with a priority.

In addition, the prediction unit 210 may not only predict performance changes, but also ultimately determine whether or not to perform asynchronous conversion. In detail, to perform asynchronous conversion for design technology co-optimization (DTCO), selective transition to asynchronous conversion needs to be considered by taking into account an effect after performing the P&R. Therefore, the prediction unit 210 may minimize unnecessary post-layout work based on a result predicted through the machine learning-based prediction or the trial P&R-based prediction method as described above, to accurately predict an impact after conversion even in an early design stage (pre-layout).

Through the process described above, the prediction unit 210 may analyze an impact of the asynchronous conversion on an integrated circuit design in advance, and provide information needed to determine whether or not to perform the conversion.

Meanwhile, the timing analysis unit 230 according to the present embodiment may analyze timing of at least one of a synchronous domain and an asynchronous domain based on a clock to determine whether a predefined timing event has occurred.

The timing analysis unit 230 according to this embodiment may perform synchronous-asynchronous hybrid timing analysis or layout effect PV aware timing analysis, or perform timing analysis based on an integration thereof.

Accordingly, the timing analysis unit 230 may selectively apply an asynchronous design through the layout effect PV aware timing analysis. That is, a block to which the asynchronous design is to be applied, or whether to apply an asynchronous design to a timing-independent part in a block may be selected.

In addition, the timing analysis unit 230 may perform timing analysis for a synchronous-asynchronous hybrid design to check a timing change in an integrated circuit design when the asynchronous design is applied.

To do so, the timing analysis unit 230 may optimize a design using a machine learning-based model or an optimization model based on feedback regarding a design to which asynchronism is to be applied. In detail, the timing analysis unit 230 may predict a layout effect process variation based on a probability model, or probabilistically predict a timing change according to a layout effect process variation using a machine learning pattern recognition model. The timing change according to the layout effect process variation predicted by the timing analysis unit 230 by using the machine learning pattern recognition model may mean a timing change according to a process variation such as an LLE or an NE that may occur in a synchronous design as described above.

In addition, the timing analysis unit 230 may include a clock domain crossing (CDC) analysis model that identifies a CDC timing event, which is a case in which a problem occurs when a signal is transmitted between domains with different clock cycles.

In detail, the CDC timing event may mean metastability, a data loss, a timing error (timing violation), etc. which occurs when data is transmitted between two domains with different clock frequencies or different phases. In particular, the CDC timing event may occur during data transmission between synchronous domains, which may degrade reliability of an integrated circuit design.

To resolve this problem, the timing analysis unit 230 may use a CDC analysis model that automatically classifies at least one CDC type when predefined CDC analysis target data is input.

At this time, the predefined CDC analysis target data may include a register transfer level (RTL) design code (Verilog, VHDL, System Verilog), a clock domain definition file (a clock domain constraint, a CDC graph), a timing analysis result (static timing analysis (STA)), placement and routing information (physical layout data), and an exploratory data analysis (EDA) tool simulation log (VCS, Questa, Jasper Gold, etc.).

In addition, the CDC analysis model that automatically classifies at least one CDC type may be provided to overcome limitations of general CDC analysis methods and predict CDC errors through data learning by utilizing machine learning (ML) and deep learning (DL) models. To do so, the CDC analysis model may be trained to automatically derive an optimal solution through transformer-based CDC pattern detection, timing analysis and CDC error risk prediction using long short-term memory (LSTM), and reinforcement learning.

Thus, the CDC analysis model may automatically classify at least one CDC type. The at least one CDC type classified by the CDC analysis model may be a path in which metastable, a data loss within an asynchronous interface, or timing contention occurs. Additionally, the CDC analysis model may also output an optimal CDC solution in a GALS structure.

In addition, when it is checked that a timing event has occurred through the CDC analysis model, the timing analysis unit 230 according to the present embodiment may enable optimization through clock synchronization adjustment by applying a handshake-based CDC interface or utilizing a phase-locked loop (PLL) or a delay-locked loop (DLL).

Meanwhile, the optimization engine 300 according to the present embodiment may derive an optimal design parameter for an integrated circuit design generated by inputting a simulation result of the simulator 200 into an optimization model provided in advance.

Here, the optimal design parameter may mean a parameter for achieving a predefined optimization objective. The optimal design parameter may include power, timing, a yield, an area, or other semiconductor-related parameters. In addition, the predefined optimization objective to be achieved through the optimal design parameter may be a predefined objective in consideration of a design objective such as power optimization, timing optimization, yield optimization, area optimization, or other semiconductor-related design objectives such as wirelength optimization, routability, and IR-drop optimization.

When a final simulation result does not satisfy a target value, the optimization engine 300 according to the present embodiment may repeatedly perform a process of deriving and transmitting a new optimization parameter to the integrated circuit design generator 100 until the target value is satisfied.

In addition, the optimal design parameter derived from the optimization engine 300 according to the present embodiment may include asynchronous design information regarding the integrated circuit design generator 100. The asynchronous design information may be information for pursuing a predefined optimization objective or a predefined asynchronous design objective. In detail, the optimal design parameter may be information for determining a block in an integrated circuit design to be converted to an asynchronous design and determining an asynchronous design method to be applied to the determined block.

To derive the optimal design parameter, the optimization engine 300 may be configured to include a target area exploration unit 310, an asynchronous method determination unit 330, and a design analysis unit 350.

The target area exploration unit 310 may explore information about a target area to which asynchronism is to be applied, among integrated circuit design areas.

Thus, the target area exploration unit 310 may explore a design area vulnerable to a layout effect PVs or a timing change as a target area using a process variation (PV) analysis model or a timing analysis model. provided in advance

The target area exploration unit 310 may explore the target area which is a design area to which an asynchronous design is selectively applied, by analyzing the design area vulnerable to layout effect process variations such as a local layout effect (LLE) and a neighborhood effect (NE) using a process variation analysis model. The process variation analysis model may be a model trained using a machine learning technique based on pattern matching, and with respect to data for learning, a simulation result from the simulator 200 may be used as learning data, or data provided through a general layout effect process variation analysis method or a method of verifying a layout may be used as learning data.

Additionally, the target area exploration unit 310 may explore a design area vulnerable to a timing change using a timing analysis model. The design area vulnerable to a timing change has a low performance margin. Thus, even a small change may have a great impact on a whole design. Accordingly, the target area exploration unit 310 may use a timing analysis model provided in advance by sequentially applying a general timing analysis method and a general process variation analysis method or combining the general timing analysis method and the general process variation analysis method in the related art to explore a design area sensitive to a timing change and set the corresponding design area as a target area.

Here, the target area may be an area including at least one among a block within the integrated circuit design and a sub-area in the block.

In particular, the target area is a block in which a high-speed data operation or high-speed data pipelining is important, and may mean an area in which performance may be significantly increased through an asynchronous design. In detail, the target area may indicate a block to which an asynchronous design is to be applied, or a sub-area which is a timing-independent part within a block to which an asynchronous design is to be applied, and may mean an area in which performance may be improved by removing a TGB.

As another example, the target area may be a block that aims for low power. In a process with a thickness of 10 nm or less in which importance of power consumption increases due to an increase in process variations, a block with high standby power consumption may be explored as a target area.

Meanwhile, the asynchronous method determination unit 330 according to the present embodiment may determine an asynchronous design method to be applied to the target area derived from the target area exploration unit 310, based on at least one of predefined asynchronous design objectives.

The asynchronous method determination unit 330 may determine the asynchronous design method according to the predefined asynchronous design objective. To do so, the asynchronous method determination unit 330 may be configured as an optimal asynchronous method recommendation model based on reinforcement learning, and explore an asynchronous method that meets the predefined asynchronous design objective and optimize the explored asynchronous method by reflecting process characteristics.

The optimal asynchronous method recommendation model is a model trained to recommend an optimal design structure based on design data, and may be a model provided to, when an asynchronous design objective is determined by a user or automatically determined in comparison with a predefined optimization objective, be capable of determining an asynchronous design method corresponding to the determined asynchronous design objective.

For example, the predefined asynchronous design objective according to the present embodiment may be at least one among low power, timing invariance, high performance, ease of process scalability, minimization of design difficulty, and an ultra-high reliability system.

When the predefined asynchronous design objective is low power, the asynchronous method determination unit 330 may determine micropipelines (bundled data+transition signaling) as an asynchronous design method to maintain simplicity of a design that enables low power by removing unnecessary clock transitions.

Alternatively, in a case of a low-power asynchronous design method, for example, in a process with a thickness of 10 nm or less, since importance of power consumption increases due to an increase in process variations, the asynchronous method determination unit 330 may set a block with high standby power consumption as a target area, and apply an asynchronous design to the target area. Then, as a clock is not present, power consumption may be greatly reduced. In this case, as an example, the asynchronous method determination unit 330 may apply at least one power optimization method to the asynchronous design method for the target area. For example, dynamic voltage & frequency scaling (DVFS) may be used to enable voltage regulation to thereby maximize power efficiency.

As another example, the asynchronous method determination unit 330 may use an advantage of an asynchronous method such that a clock reset is not needed, by combining DVFS with power gating which is one of general power optimization methods to maximize power efficiency.

In addition, when a preset asynchronous design objective is timing invariance, the asynchronous method determination unit 330 may determine, as an asynchronous design method, an asynchronous structure in which quasi-delay insensitive (QDI) and dual-rail encoding which may minimize an impact of delay are combined to secure timing stability and be robust to external environmental changes as an independent structure.

In addition, when the preset asynchronous design objective is high performance, the asynchronous method determination unit 330 may determine, as the asynchronous design method, an asynchronous structure in which dual-rail and data-dependent timing which may vary an operation speed depending on data are combined to enable faster operation than that in a synchronous design or elimination of unnecessary operations.

In addition, when the preset asynchronous design objective is ease of process scaling, the asynchronous method determination unit 330 may determine, as the asynchronous design method, bundled data with speed-independent control capable of maintaining a form similar to that in an existing synchronous design to facilitate application to automation and synthesis tools or to reduce a global clock problem.

In addition, when the preset asynchronous design objective is to minimize design difficulty, the asynchronous method determination unit 330 may determine micropipelines (bundled data) as the asynchronous design method to facilitate conversion of an existing synchronous design into an asynchronous design and enable simple verification and synthesis.

In addition, when the preset asynchronous design objective is an ultra-high reliability system, the asynchronous method determination unit 330 may determine, as the asynchronous design method, quasi-delay-insensitive (QDI) (fully delay-insensitive+dual-rail) capable of minimizing timing variability to maximize reliability or be equipped with an error detection function therein.

In addition, the asynchronous method determination unit 330 may optimize the asynchronous design method to suit a process by reflecting impacts of timing characteristics or a cell library in particular processes, e.g., with a thickness of 28 nm or 7 nm, and may automatically determine the asynchronous design method based on PPA results such as power, performance, and area.

Meanwhile, when a target area is derived by the target area exploration unit 310, the design analysis unit 350 according to the present embodiment may recommend design options for an asynchronous design based on a purpose and intention of an integrated circuit design applied to the target area.

The design analysis unit 350 may recommend options such as a first option using a GALS method in which a synchronous design is recommended for operation between respective cores and an asynchronous design is recommended for data exchange when an integrated circuit design includes a multi-processor, or a second option of connecting interfaces between a graphics processing unit (GPU), a central processing unit (CPU), and a memory to operate asynchronously in a case of a system on chip (SoC), or a third option of enabling a high-speed and low-power design by using a computational module in a GALS method in a case of an artificial intelligence (AI) accelerator.

In detail, when GALS is selected among design options applied to the target area, the design analysis unit 350 according to the present embodiment may derive an optimal design parameter for performing synchronous-asynchronous interface optimization.

In the GALS, a first-in-first-out (FIFO) buffer is important for data transfer between synchronous domains. Therefore, an optimal design parameter for performing synchronous-asynchronous interface optimization may be a parameter for performing FIFO buffer optimization according to at least one among buffer size optimization between synchronous domains, low-latency FIFO application optimization, or FIFO application optimization according to a comparison between memory-based FIFO and register-based FIFO.

In detail, the parameter for performing such FIFO buffer optimization may include at least one among a placement optimization parameter capable of independently placing blocks of a synchronous domain to prevent clock collisions, a placement optimization parameter capable of placing blocks of domains with a same clock adjacent to each other by performing clock tree clustering by applying a multi-source clock tree analysis method, and an SI optimization parameter through signal integrity verification for an asynchronous interface to prevent signal collisions between asynchronous domains.

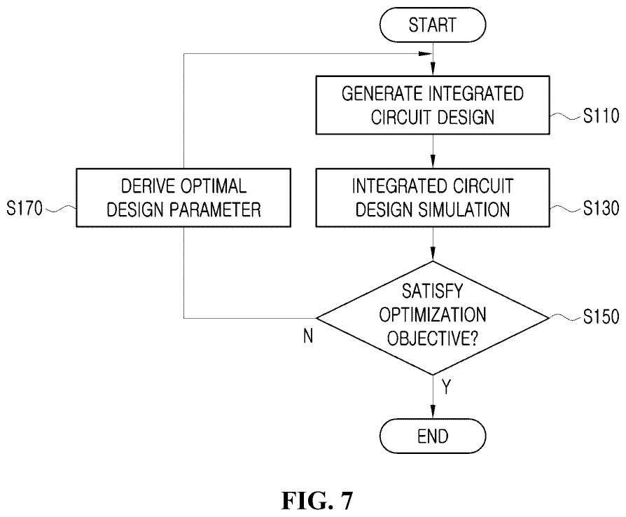

Meanwhile, FIG. 7 is a flowchart for explaining an integrated circuit optimization design method according to an embodiment of the present disclosure.

In the optimization design method according to the present embodiment, the integrated circuit design generator 100 may generate an integrated circuit design (S110).

Then, the simulator 200 may simulate the generated integrated circuit design (S130).

Then, the optimization engine 300 may input a result of the simulation obtained from the simulator 200 into an optimization model provided in advance to derive an optimal design parameter for the generated integrated circuit design (S170). To do so, prior to the deriving of the optimal design parameter (S170), determining (S150), by the optimization engine 300, whether the generated integrated circuit design achieves an optimization objective may be further included.

The optimal design parameter derived in the deriving of the optimal design parameter (S170) may include asynchronous design information regarding the integrated circuit design generator 100.

In addition, the deriving of the optimal design parameter (S170) may include exploring, by the target area exploration unit 310, information about a target area to which asynchronism is applied among integrated circuit design areas.

The exploring of the target area information may be exploring of, as the target area, a design area vulnerable to a layout effect process variation or a timing variation using a process variation (PV) analysis model or a timing analysis model provided in advance.

Here, the target area may be an area including at least one among a block within the integrated circuit design and a sub-area in the block.

After the deriving of the optimal design parameter (S170), the integrated circuit design generator 100 may asynchronously generate at least a part of the integrated circuit design according to the derived optimal design parameter to change the generated integrated circuit design.

The integrated circuit optimization design method in the present disclosure may be implemented in a form of program instructions that may be executed through various computer components and recorded in a computer-readable recording medium. The computer-readable media may include program commands, data files and data structures solely or in combination.

The program commands recorded on the computer-readable recording medium may be specially designed and configured for the present disclosure or may be known and available to those skilled in the art in the computer software field.

For example, the computer-readable recording media include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory.

Examples of program code include both machine language codes produced by a compiler, and as well as a high-level language code that may be used by an interpreter etc. to be executed by a computer. The above hardware device may be configured to operate as one or more software modules to perform processing according to the present disclosure, and vice versa.

Although various embodiments of the present disclosure are illustrated and described, the present disclosure is not limited to the particular embodiments described above and various changes and modifications thereof may be made by those skilled in the art without departing from the essence of the disclosure as claimed in the claims. Such changes and modifications should not be understood as being separate from the technical idea or viewpoint of the present disclosure.

### EXPLANATION OF REFERENCE NUMERALS

10: integrated circuit optimization design device
100: integrated circuit design generator
200: simulator
210: prediction unit
230: timing analysis unit
300: optimization engine
310: target area exploration unit
330: asynchronous method determination unit
350: design analysis unit

1. An integrated circuit optimization design device comprising:
an integrated circuit design generator configured to generate an integrated circuit design;
a simulator configured to simulate the integrated circuit design; and
an optimization engine configured to derive an optimal design parameter for the integrated circuit design by inputting a simulation result obtained from the simulator into an optimization model provided in advance,
wherein the optimal design parameter comprises asynchronous design information regarding the integrated circuit design generator, and
wherein the integrated circuit design generator asynchronously generates at least a part of the integrated circuit design according to the optimal design parameter to change the integrated circuit design.

2. The integrated circuit optimization design device of claim 1, wherein the optimization engine comprises a target area exploration unit configured to explore information about a target area to which asynchronism is to be applied among areas of the integrated circuit design.

3. The integrated circuit optimization design device of claim 2, wherein the target area exploration unit explores, as the target area, a design area vulnerable to a layout effect process variation or a timing variation using a process variation (PV) analysis model or a timing analysis model, each provided in advance.

4. The integrated circuit optimization design device of claim 3, wherein the target area is an area comprising at least one of a block within the integrated circuit design and a sub-area in the block.

5. The integrated circuit optimization design device of claim 3, wherein the simulator comprises an estimator configured to predict asynchronous applicability by verifying whether a target value corresponding to a predefined optimization objective is reached.

6. The integrated circuit optimization design device of claim 5, wherein the simulator further comprises a timing analysis unit configured to determine whether a predefined timing event occurs by analyzing timing for at least one of a synchronous domain and an asynchronous domain based on a clock.

7. The integrated circuit optimization design device of claim 6,
wherein the timing analysis unit comprises a clock domain crossing (CDC) analysis model configured to identify a CDC timing event,
wherein the CDC timing event is a case in which a problem occurs when a signal is transmitted between domains with different clock cycles, and
wherein the CDC analysis model is configured to automatically classify at least one CDC type when predefined CDC analysis target data is input.

8. The integrated circuit optimization design device of claim 7, wherein the optimization engine further comprises an asynchronous method determination unit configured to determine an asynchronous design method to be applied to the target area based on at least one of predefined asynchronous design objectives.

9. The integrated circuit optimization design device of claim 7, wherein the optimization engine further comprises a design analysis unit configured to recommend a design option for an asynchronous design based on the integrated circuit design applied to the target area when the target area is derived by the target area exploration unit.

10. The integrated circuit optimization design device of claim 9, wherein the integrated circuit design generator changes the integrated circuit design by placing blocks in the domains with a same clock to be adjacent to each other, or by independently placing the blocks in synchronous domains and performing an interface routing, and prevent a signal collision between asynchronous domains, based on the optimal design parameter.

11. The integrated circuit optimization design device of claim 10, wherein the integrated circuit design generator converts the target area from the synchronous domain to the asynchronous domain.

12. An integrated circuit optimization design method comprising:
generating, by an integrated circuit design generator, an integrated circuit design;
simulating, by a simulator, the integrated circuit design;
deriving, by an optimization engine, an optimal design parameter for the integrated circuit design by inputting a simulation result obtained from the simulator into an optimization model provided in advance,
wherein the optimal design parameter comprises asynchronous design information regarding the integrated circuit design generator, and
wherein the integrated circuit design generator asynchronously generates at least a part of the integrated circuit design according to the optimal design parameter to change the integrated circuit design.

13. The integrated circuit optimization design method of claim 12, wherein the deriving the optimal design parameter comprises exploring, by a target area exploration unit, information about a target area to which asynchronism is applied among areas of the integrated circuit design.

14. The integrated circuit optimization design method of claim 13, wherein the exploring the information about the target area comprises exploring, as the target area, a design area vulnerable to a layout effect process variation or a timing variation using a process variation (PV) analysis model or a timing analysis model, each provided in advance.

15. The integrated circuit optimization design method of claim 14, wherein the target area is an area comprising at least one of a block within the integrated circuit design and a sub-area in the block.
